(19) United States
(12) Patent Application Publication
(10) Pub. No.: US 2025/0034724 A1
(43) Pub. Date: Jan. 30, 2025

(54) ELECTROCHEMICAL REDUCTION OF NITROGEN TO AMMONIA CATALYZED BY POLYOXOMETALATES

(71) Applicant: YEDA RESEARCH AND DEVELOPMENT CO. LTD., Rehovot (IL)

(72) Inventors: Ronny NEUMANN, Kfar Saba (IL); Avra TZAGUY, Rehovot (IL)

(73) Assignee: YEDA RESEARCH AND DEVELOPMENT CO. LTD., Rehovot (IL)

(21) Appl. No.: 18/714,565

(22) PCT Filed: Nov. 30, 2022
(86) PCT No.: PCT/IL2022/051276

§ 371 Date: May 29, 2024

(30) Foreign Application Priority Data
Dec. 2, 2021 (IL) 288627

(51) Int. Cl. C25B 1/27; C25B 11/085

(52) U.S. Cl. CPC C25B 1/27; C25B 11/085

(57) ABSTRACT

This invention is directed to a method of electrocatalytic reduction of dinitrogen (N2) to ammonia using a poly oxometalate catalyst, an alkali metal cation and a donor of a proton and/or an electron.

### FIELD OF INVENTION

This invention is directed to a method of electrocatalytic reduction of nitrogen to ammonia using a polyoxometalate catalyst in the presence of an alkali metal cation and a donor of a proton and/or an electron.

### BACKGROUND OF THE INVENTION

Humankind is dependent on the manufacture of ammonia and its derivatives as fertilizers for food production. The dinitrogen to ammonia Haber-Bosch (H-B) process is therefore said to be the most important invention of the 20^{th} century (Smith, C; Hill, A. K.; Torrente-Murciano, L. Current and Future Role of Haber-Bosch Ammonia in a Carbon-Free Energy Landscape. Energy Environ. Sci. 2020, 13, 331-344. The highly optimized heterogeneous catalytic process, N₂+3H₂→2NH₃, is only feasible at high temperatures (˜700 K) and pressures (˜200 bar) using very high purity N₂ and H₂ (Schlögl, R. in Handbook of Heterogeneous Catalysis 2501-2575 (Wiley-VCH Verlag Gmbh & Co. KGaA, 2008). The needed H₂ is produced via steam reforming from natural gas and it is estimated that ˜1% of the world's energy consumption and 1.4% of global CO₂ emissions are related to the H-B process (MacFarlane, D. R.; Cherepanov, P. V.; Choi, J.; Suryanto, B. H. R.; Hodgetts, R. Y.; Bakker, J. M.; Ferrero Vallana, F. M.; Simonov, A. N. A Roadmap to the Ammonia Economy. Joule 2020, 4, 1185-1205). Thus, NH₃ is produced at locations where natural gas is plentiful but not necessarily where the end-users are located. Based on the future availability of renewable electricity two options have been put forward to replace the traditional H-B process. The hybrid-H-B approach uses H₂ from water electrolysis for H-B NH₃ synthesis, which obviates the use of natural gas and reduces the overall carbon footprint leading to decarbonization of the process.

The other option, electrocatalytic NH₃ synthesis (e-NH₃), proceeds via an electrochemical Nitrogen Reduction Reaction (e-N₂RR) obtaining the needed protons and electrons from water oxidation. In contrast to the hybrid-H-B, e-N₂RR is thermodynamically favourable at ambient conditions and a catalytic reaction can be feasible under much more benign conditions. In fact, the nitrogenase enzyme complex reduces N₂ to NH₃ albeit quite inefficiently using 16 equivalents of ATP (Adenosine triphosphate) per N₂ molecule (Hoffman, B. M.; Lukoyanov, D.; Yang, Z.-Y.; Dean, D. R.; Seefeldt, L. C. Mechanism of Nitrogen Fixation by Nitrogenase: The Next Stage. Chem. Rev. 2014, 114, 4041-4062). An economic analysis of hybrid H-B and e-NH₃ approaches shows that while the former can be economically feasible in a large production scale, e-NH₃ can outperform it in a small production scale (˜0.03 ton_{NH3}/day) (Fernandez, C. A.; Hatzell, M. C. Economic Considerations for Low-Temperature Electrochemical Ammonia Production: Achieving Haber-Bosch Parity. J. Electrochem. Soc. 2020, 167, 143504). Climate benefits of e-NH₃ include reduced carbon footprint associated with reduced maritime and overland transportation, reduced storage needs, enhanced ability to follow the intermittent electrical power input, and use of nitrogen with reduced purity. Together all these factors make decentralized ammonia production an attractive long-term option (Soloveichik, G. Electrochemical synthesis of ammonia as a potential alternative to the Haber-Bosch process. Nat. Catal. 2019, 2, 377-380).

On-site, on-demand NH₃ production will also improve decarbonization of agricultural and shipping sectors in and be more resistant against political-economic risks, which can decrease the availability of ammonia especially in rural areas (Arora, P.; Hoadley, A. F. A.; Mahajani, S. M; Ganesh, A. Small-Scale Ammonia Production from Biomass: A Techno-Enviro-Economic Perspective. Ind. Eng. Chem. Res. 2016, 55, 6422-6434).

Despite the advances toward both understanding N₂ activation and NH₃ formation, electrocatalytic reduction to NH₃, (electro) catalyst development is still very much lagging behind (Chalkley, M. J.; Drover, M. W.; Peters, J. C. Catalytic N₂-to-NH₃ (or —N₂H₄) Conversion by Well-Defined Molecular Coordination Complexes. Chem. Rev. 2020, 120, 5582-5636).

It should also be noted that previous reports of e-N₂RR reactions carried out in water as solvent and electron/proton donor, however, have been shown to be incorrect (Anderson, S. Z.; Coloci, V.; Yang, S.; Schwalbe, J. A.; Nielander, A. C.; McEnaney, J. M.; Enemark-Rassmussen, K.; Baker, J. G.; Singh, A. R.; Rohr, B. A.; Statt, M. J.; Blair, S. J.; Mezzavilla, S.; Kibsgaard, J.; Vesborg, R. C. K.; Cargnello, M.; Bent, S. F.; Jaramillo, T. F.; Stephens, I. E. L.; Nørskov, J. K.; Chorkendorff, I. A rigorous electrochemical ammonia synthesis protocol with quantitative isotope measurements. Nature, 570, 504-508 (2019).

Polyoxometalates are attractive as catalysts because they are easy to synthesize, thermally and oxidatively stable, their intrinsic properties may be modified easily and they can be used with excellent efficiency in transformations involving electron transfer (Neumann, R. Activation of Molecular Oxygen, Polyoxometalates and Liquid Phase Catalytic Oxidation. Inorg. Chem. 2010, 49, 3594-3601.)

The substitution of a lacunary polyoxometalate with transition metals increases the reactivity of the polyanion, which normally have surfaces that are populated with weakly basic oxygen atoms. As a rational approach to such complexes, lacunary anions such as α-or β-[SiW₉O₃₄]⁹⁻ were prepared (G. Herve and A. Teze, Study of alpha-and. beta.-enneatungstosilicates and-germanates Inorg. Chem., 1977,16, 2115-2117) and then used to prepare tri-transition metal substituted polyoxometalates. For example [SiW₉M₃(L)₃O₃₇]ⁿ⁻ anions where M=Co (II), Fe (III), Cu (II), Mn (II), Ni (II), Cr (III), Al (III), and Ga (III) (Liu, J.; Ortega, F.; Sethuraman, P.; Katsoulis, D. E.; Costello, C. E.; Pope, M. T. Trimetallo Derivatives of Lacunary 9-Tungstosilicate. J. Chem. Soc., Dalton Trans. 1992, 1901-1906).

There is a need for an electrochemical method for the preparation of ammonia from dinitrogen (N₂) at low negative cathodic potentials and with water as proton/electron donor. Such a method would enable small ammonia production units in decentralized manufacture schemes.

### SUMMARY OF THE INVENTION

In some embodiments, this invention provides a method of reduction of dinitrogen (N₂) to ammonia (NH₃), wherein the method comprises an electrochemical reduction of N₂ in an electrochemical cell in the presence of a polyoxometalate catalyst, an alkali metal cation, and a donor of a proton and/or an electron.

In some embodiments, the reduction of dinitrogen disclosed herein is conducted in the presence of a polyoxometalate catalyst having the general formula (Q)ₙ[XFe₂M(L)₃W₉O₃₇] or solvate thereof wherein:
X is P, Si, As, Ge, Ga, B, or Al;
M is Cr, Mn, Fe, Co, Ni, Cu, Zn, Al, Ga, Sc, Mg, Y, Ba, or Ca;
L is H₂O, carboxylate, oxyanion, sulfate, perchlorate, halide, pseudohalide, null or any combinations thereof;
Q is a cation selected from the group consisting of a proton, an alkali metal cation, an alkaline earth metal cation, a lanthanide cation, a nitrogen centered cation, a phosphorous centered cation and combinations thereof; and
n is an integer between 3-17.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a presentation of the polyoxometalate, (Q)ₙ[XFe₂M(H₂O)₃W₉O₃₇] where M is Fe. The counter cations are not shown.

FIGS. 2A-2D depict the UV-Vis spectra of (TBA)₇[SiFe₃(H₂O)₃W₉O₃₇] without Li* (FIGS. 2A, 2B) and with Li* (FIGS. 2C, 2D) under He (FIGS. 2A, 2C) or N₂ (FIGS. 2B, 2D). The measurements were made using 40 μM (TBA)-[SiFe₃(H₂O)₃W₉O₃₇], 0.01 M TBAPF₆, 200 μM LiClO₄ (FIGS. 2C, 2D) in THF. The reference solution was 0.01 M TBAPF₆ in THF. In situ electrolysis was carried out in 1 cm quartz cuvette using a Pt gauze working electrode, a Pt wire counter electrode and Ag wire are reference electrode at −1.8 V versus Ag wire (-1.93 versus SHE by calibration). Black: before electrolysis; medium dark gray: 1-electron per (TBA)-[SiFe₃(H₂O)₃W₉O₃₇]; very dark gray: 2-electron per (TBA) [SiFe₃(H₂O)₃W₉O₃₇]; light gray: 3-electron per (TBA)₇[SiFe₃(H₂O)₃W₉O₃₇] and gray: 4-electron per (TBA)₇[SiFe₃(H₂O)₃W₉O₃₇]. The UV-Vis spectra show that while N₂ apparently binds to (TBA)₇[SiFe₃(H₂O)₃W₉O₃₇] (FIG. 2B) in the presence of Li* further reduced species are formed (FIG. 2D).

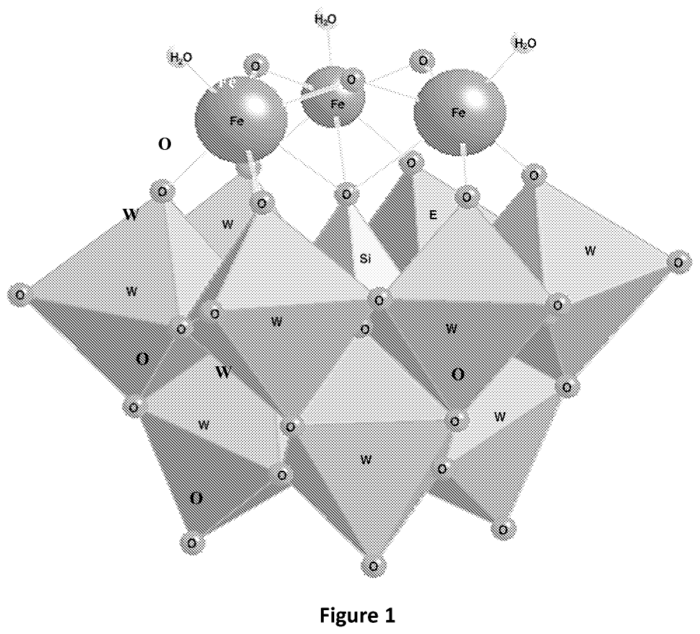

It will be appreciated that for simplicity and clarity of illustration, elements shown in the Figure have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention is directed to a method for the reduction of dinitrogen (N₂) to ammonia (NH₃). The method provided herein, for the reduction of dinitrogen (N₂) to ammonia (NH₃) is catalyzed by a polyoxometalate catalyst and an alkali metal cation in the presence a donor of a proton and/or an electron.

In some embodiments, this invention provides a method of reduction of dinitrogen (N₂) to ammonia (NH₃), wherein the method comprises an electrochemical reduction of N₂ in an electrochemical cell in the presence of a polyoxometalate catalyst, an alkali metal cation, a donor of a proton and/or an electron and optionally in the presence of a solvent.

In some embodiments, this invention provides a method of reduction of dinitrogen (N₂) to ammonia (NH₃), wherein the method comprises an electrochemical reduction of N₂ in an electrochemical cell in the presence of a polyoxometalate catalyst, an alkali metal cation, a donor of a proton and/or an electron and optionally in the presence of an electrolyte.

In some embodiments, this invention provides a method of reduction of dinitrogen (N₂) to ammonia (NH₃), wherein the method comprises an electrochemical reduction of N₂ in an electrochemical cell in the presence of a polyoxometalate catalyst, an alkali metal cation, a donor of a proton and/or an electron and optionally in the presence of an electrolyte and a solvent.

The reduction of N₂ to NH₃ can be carried out as described in Scheme 1, wherein the alkali metal cation is sodium, and the donor of a proton and/or electron is water:

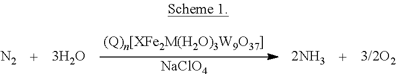

In some embodiments, the polyoxometalate catalyst comprises at least two iron (Fe) ions. In one embodiment, the polyoxometalate catalyst comprises two iron (Fe) ions. In one embodiment, the polyoxometalate catalyst comprises three iron (Fe) ions.

In some embodiments, the reduction of dinitrogen (N₂) disclosed herein is conducted in the presence of a polyoxometalate catalyst having the general formula (Q)ₙ[XFe₂M(L)₃W₉O₃₇] or solvate thereof wherein:
X is P, Si, As, Ge, Ga, B, or Al;
M is Cr, Mn, Fe, Co, Ni, Cu, Zn, Al, Ga, Sc, Mg, Y, Ba, or Ca;
L is H₂O, carboxylate, oxyanion, halide, pseudohalide, null or any combinations thereof;
Q is a cation selected from the group consisting of a proton, an alkali metal cation, an alkaline earth metal cation, a lanthanide cation, a nitrogen centered cation, a phosphorous centered cation and combinations thereof; and
n is an integer between 3-17.

In some embodiments Q of (Q)ₙ[XFe₂M(L)₃W₉O₃₇] is a cation selected from the group consisting of a proton, an alkali metal cation, an alkaline earth metal cation, a lanthanide cation, a nitrogen centered cation, a phosphorous centered cation and combinations thereof. In other embodiments, Q is a proton. In other embodiments, Q is an alkali metal cation. In other embodiments, Q is an alkaline earth metal cation. In other embodiments, Q is a lanthanide cation. In other embodiments, Q is a nitrogen centered cation. In other embodiments, Q is a phosphorous centered cation.

In some embodiments Q of (Q)ₙ[XFe₂M(L)₃W₉O₃₇] is an alkali metal cation.

In some embodiments, Q of (Q)ₙ[XFe₂M(L)₃W₉O₃₇] is R₁R₂R;R₄N+wherein:
R₁ is H, alkyl, aryl, alkylaryl,:
R₂ is H, alkyl, tallow, aryl, alkylaryl, or C_{y}H_{2y+1} where y≥8, or C_{z}H₂z+1COOH where z≥7; and
R₃ and R₄ are each independently H, alkyl, aryl, alkylaryl, (CH₂CH₂O)ₘCH₂CH₂R₅, (CH₂CH₂O) mH or
CH₂CH₂ (OCH₂CH₂)ₘR₅ where m≥3, wherein R₅ is H, OH, alkyl, halide or pseudohalide.

In another embodiment, R₁ is ethyl; R₂ is C_{z}H_{2z+1}COOH where z≥7; and R₃ and R₄ are (CH₂CH₂O)ₘH where m=6-20. In another embodiment, R₁ is methyl; R₂ is tetradecyl, hexadecyl or octadecyl; and R₃ and R₄ are (CH₂CH₂O)ₘH where m=5-10.

In other embodiments, Q is R₁R₂R₃R₄N⁺ wherein R₁, R₂, R₃, and R₄ are each independently H, alkyl, aryl or alkylaryl.

In some embodiments, Q is R₁R₂R,RAN+wherein R₂ is C_{y}H_{2y+1} where y≥8. In other embodiments. y is an integer between 8 and 50. In other embodiments, y is an integer between 8 and 40. In other embodiments, y is an integer between 8 and 30. In other embodiments, y is an integer between 8 and 20. In some other embodiments, Q is tetrabutylammonium (TBA). In one other embodiment, Q is R₁R₂R₃R₄N⁺ wherein R₁ is ethyl, R₂ is tallow and R₃ and R₄ are CH₂ CH₂ (OCH₂CH₂)ₘOH.

As used herein, the term “alkyl”, used alone or as part of another group, refers, in one embodiment, to a “C₁ to C₁₂ alkyl” and denotes linear and branched, saturated or unsaturated (e.g., alkenyl, alkynyl) groups, the latter only when the number of carbon atoms in the alkyl chain is greater than or equal to two, and can contain mixed structures. Non-limiting examples are alkyl groups containing from 1 to 6 carbon atoms (C₁ to C₆ alkyls), or alkyl groups containing from 1 to 4 carbon atoms (C₁ to C₄ alkyls). Examples of saturated alkyl groups include, but are not limited to, methyl, ethyl, n-propyl, isopropyl, n-butyl, iso-butyl, sec-butyl, tert-butyl, amyl, tert-amyl and hexyl. Examples of alkenyl groups include, but are not limited to, vinyl, allyl, butenyl and the like. Examples of alkynyl groups include, but are not limited to, ethynyl, propynyl and the like. Similarly, the term “C₁ to C₁₂ alkylene” denotes a bivalent radical of 1 to 12 carbons.

The alkyl group can be unsubstituted, or substituted with one or more substituents selected from the group consisting of halogen, hydroxy, alkoxy, aryloxy, alkylaryloxy, heteroaryloxy, oxo, cycloalkyl, phenyl, heteroaryls, heterocycl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, alkylthio, arylthio, or alkylsulfonyl groups. Any substituents can be unsubstituted or further substituted with any one of these aforementioned substituents.

The term “alkylaryl” used herein alone or as part of another group, refers to, in some embodiments, to an alkyl group as defined above, which is substituted by an aryl as defined herein.

The term “aryl” used herein alone or as part of another group denotes an aromatic ring system containing from 6-14 ring carbon atoms. The aryl ring can be a monocyclic, bicyclic, tricyclic and the like. Non-limiting examples of aryl groups are phenyl, naphthyl including 1-naphthyl and 2-naphthyl, and the like. The aryl group can be unsubstituted or substituted through available carbon atoms with one or more groups such as halogen, hydroxy, alkoxy, aryloxy, alkylaryloxy, heteroaryloxy, oxo, cycloalkyl, phenyl, heteroaryls, heterocyclyl, naphthyl, amino, alkylamino, arylamino, heteroarylamino, dialkylamino, diarylamino, alkylarylamino, alkylheteroarylamino, arylheteroarylamino, acyl, acyloxy, nitro, carboxy, carbamoyl, carboxamide, cyano, sulfonyl, sulfonylamino, sulfinyl, sulfinylamino, thiol, alkylthio, arylthio, or alkylsulfonyl groups. Any substituents can be unsubstituted or further substituted with any one of these aforementioned substituents.

In some embodiments, Q is R₁R₂R₃R₄N⁺ wherein R₂ is C_{z}H_{2z+1}COOH where z≥7. In other embodiments. z is an integer between 7 and 50. In other embodiments, z is an integer between 7 and 40. In other embodiments, z is an integer between 7 and 30. In other embodiments, z is an integer between 7 and 20.

In some embodiments, Q is R₁R₂R₃R₄N⁺ wherein R₃ and R₄ are the same or different. In some embodiments, are each independently (CH₂CH₂O)ₘCH₂CH₂R₅ where m≥3. In other embodiments. m is an integer between 3 and 50. In other embodiments, m is an integer between 3 and 40. In other embodiments, m is an integer between 3 and 30. In other embodiments. m is an integer between 3 and 20. In other embodiments. m is an integer between 3 and 10.

In some embodiments, Q is R₁R₂R₃R₄N⁺ wherein R₁ is ethyl, R₂ is C₂H_{2z+1}COOH wherein z≥7 and R₃ and R₄ are (CH₂CH₂O)ₘH where m=6-20. In other embodiments, Q is R₁R₂R₃RAN+wherein R₁ is methyl; R₂ is tetradecyl, hexadecyl or octadecyl; and R₃ and R₄ are (CH₂CH₂O)ₘH where m=5-10.

In some embodiments X of (Q) [XFe₂M(L)₃W₉O₃₇] is X is P, Si, As, Ge, Ga, B, or Al. In other embodiments X is P. In other embodiments X is Si. In other embodiments X is As. In other embodiments X is Ge. In other embodiments X is Ga. In other embodiments X is B. In other embodiments X is Al.

In some embodiments n of (Q)ₙ[XFe₂M(L)₃W₉O₃₇] is an integer between 3-17. In another embodiment, n is an integer between 3-15. In another embodiment, n is an integer between 3-12. In another embodiment, n is an integer between 3-10. In another embodiment, n is an integer between 3-8. In another embodiment, n is an integer between 3-6. In another embodiment, n is 7.

In some embodiments M of (Q)ₙ[XFe₂M(L)₃W₉O₃₇] is independently Cr, Mn, Fe, Co, Ni, Cu, Zn, Al, Ga, Sc, Mg, Y, Ba, or Ca. In other embodiments M is Cr. In other embodiments M is Mn. In other embodiments M is Fe. In other embodiments M is Co. In other embodiments M is Ni. In other embodiments M is Cu. In other embodiments M is Zn. In other embodiments M is Al. In other embodiments M is Ga. In other embodiments M is Sc. In other embodiments M is Mg. In other embodiments M is Y. In other embodiments M is Ba. In other embodiments M is Ca. In another embodiment, the polyoxometalate catalyst comprise at least two Fe ions. In other embodiments, M of (Q)ₙ[XFe₂M(L)₃W₉O₃₇] is selected from Cr(0-III), Mn(0-V), Fe(0-IV), Co(0-III), Ni(0-III), Cu(0-III), Zn(II), Al(III), Ga(III), Sc(III), Mg(II), Y(III), Ba(II) or Ca(II).

In some embodiments L of (Q)ₙ[XFe₂M(L)₃W₉O₃₇] is H₂O, carboxylate, oxyanion, halide, pseudohalide, null or any combinations thereof. In other embodiments L is H₂O. In other embodiments L is carboxylate. Non limiting examples of a carboxylate include an acetate. In other embodiments L is oxyanion. Non limiting examples of an oxyanion include nitrate, sulfate or perchlorate. In other embodiments L is sulfate. In other embodiments L is perchlorate. In other embodiments L is halide. In other embodiments L is pseudohalide. In other embodiments L is null.

In some embodiments the polyoxometalate comprises an anion [SiFe₃(L))₃W₉O₃₇]ⁿ. In other embodiments, the anion is [SiFe₃(H₂O)₃W₉O₃₇]⁷⁻.

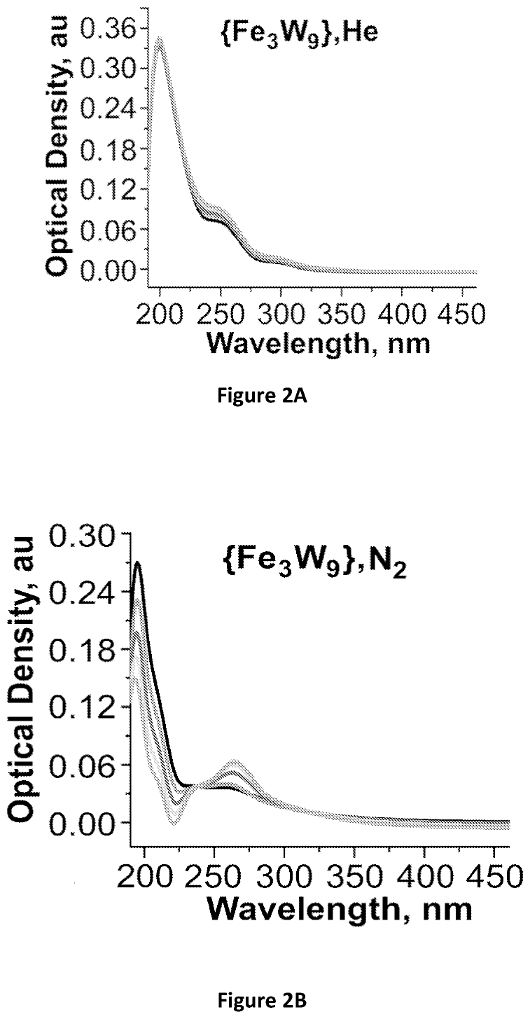

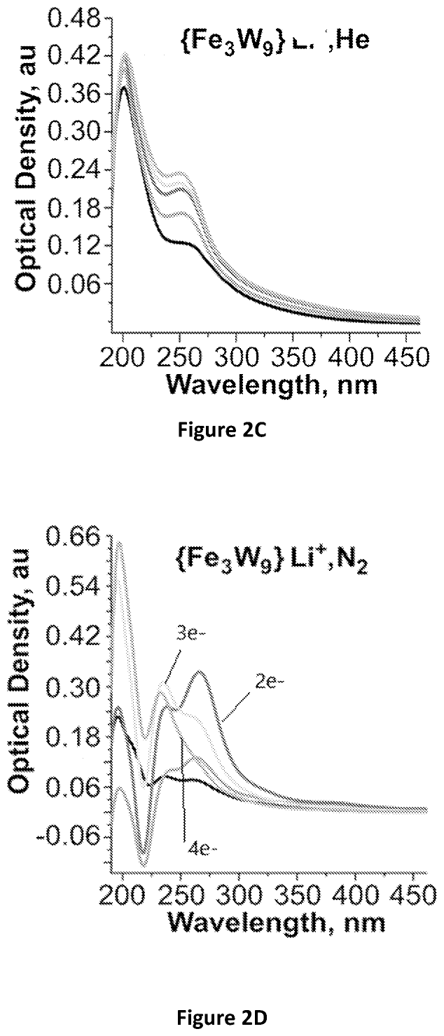

The reduction of dinitrogen of this invention is conducted in the presence of an alkali metal cation, which is provided as an alkali metal salt. As shown in FIG. 2 (and detailed in the corresponding “Brief Description of the Drawing”), the presence of an alkali cation enables the reaction of N₂ under reducing conditions of at least −1.93 V versus SHE.

In other embodiments, the alkali metal salt comprises a cation comprising lithium, sodium, potassium, rubidium or cesium ion; and an anion comprising a halide, pseudohalide, perchlorate, bis (trifluoromethylsulfonyl) imide, tetrafluoroborate, hexafluorophosphate, triflate, or other oxyanions ions. In other embodiments, the alkali metal salt comprises sodium perchlorate, sodium triflate or potassium triflate. In another embodiment the molar ratio of the alkali metal cation and the polyoxometalate catalyst is at least 3 moles of alkali metal cation per 1 mole of polyoxometalate catalyst. In another embodiment the molar ratio of the alkali metal cation and the polyoxometalate catalyst is 3-1000 moles of the alkali metal cation per 1 mole of polyoxometalate catalyst. In other embodiments the molar ratio of the alkali metal cation and the polyoxometalate catalyst is 3-500, 3-400, 3-300, 3-200, 3-100, 3-80, 3-60, 3-50, 3-40, 3-30 or 3-20 moles of metal cation per 1 mole of polyoxometalate catalyst. In another embodiment, the concentration of the alkali metal salt is between 0.01-1 M. In another embodiment, the concentration of the alkali metal salt is between 0.01-0.025 M. In another embodiment, the concentration of the alkali metal salt is between 0.01-0.05 M. In another embodiment, the concentration of the alkali metal salt is between 0.01-0.1 M. In another embodiment, the concentration of the alkali metal salt is between 0.01-0.5 M. In another embodiment, the concentration of the alkali metal salt is between 0.025-1 M. In another embodiment, the concentration of the alkali metal salt is between 0.025-0.05 M. In another embodiment, the concentration of the alkali metal salt is between 0.025-0.1 M. In another embodiment, the concentration of the alkali metal salt is between 0.025-0.5 M. In another embodiment, the concentration of the alkali metal salt is between 0.05-1 M. In another embodiment, the concentration of the alkali metal salt is between 0.05-0.1 M. In another embodiment, the concentration of the alkali metal salt is between 0.05-0.5 M. In another embodiment, the concentration of the alkali metal salt is between 0.1-1 M. In another embodiment, the concentration of the alkali metal salt is between 0.1-0.5 M. In another embodiment, the concentration of the alkali metal salt is between 0.5-1M. In another embodiment, the concentration of the alkali metal salt is 0.025, 0.067, 0.125 or 0.1 M.

The reduction of dinitrogen of this invention is conducted in the presence of a donor of a proton and/or an electron. In some embodiments, the donor of a proton and/or an electron is H₂O or an alcohol. In other embodiments the donor is H₂O. In another embodiment the donor is H₂O, introduced as vapor. In other embodiments, the donor is an alcohol. Non limiting examples of an alcohol include ethanol, methanol, isopropanol, t-butanol or combination thereof. In other embodiments, the donor is dissolved in the solvent at a concentration of ≤5 vol %. In other embodiments, the donor of a proton and/or an electron is dissolved in the solvent at a concentration of ≤2 vol %. In other embodiments, the donor is dissolved in the solvent at a concentration of between 0.1 and 5 vol %. In other embodiments, the donor is dissolved in the solvent at a concentration of between 0.1 and 2 vol %. In other embodiments, the donor is dissolved in the solvent at a concentration of between 0.5 and 2 vol %. In other embodiments, the donor is dissolved in THF or glyme at a concentration of ≤2 vol %. In other embodiments, the donor is dissolved in THF or glyme at a concentration of between 0.1 and 2 vol %. In other embodiments, the donor is dissolved in polyethylene glycol at a concentration of ≤1.5 vol %. In other embodiments, the donor is dissolved in polyethylene glycol at a concentration of between 0.1 and 1.5 vol %. In other embodiments, the donor is in vapor phase. In other embodiments the donor is dissolved in derivatives of polyethylene glycol (e.g. any ether of a PEG or carboxylate of a PEG).

In some embodiments, the reduction of dinitrogen (N₂) of this invention is conducted in the presence of a solvent. In some embodiments, the reduction of dinitrogen (N₂) of this invention is conducted with no solvent. In other embodiments, the solvent is a polyether (e.g. polyethylene glycol of any molecular weight), THF or glyme. In other embodiments, the solvent is an ether. In other embodiments, the solvent is a polyether. In other embodiments, the solvent is polyethylene glycol. In other embodiments, the solvent is THF. In other embodiments, the solvent is glyme. In other embodiments, the solvent is an ether. In one embodiment the solvent is a polyether.

In some embodiments, the reduction of dinitrogen (N₂) of this invention is an electrocatalytic reaction conducted in an electrochemical cell. In other embodiments, the electrochemical cell comprises a cathode, an anode, an alkali metal cation and a donor of a proton and/or an electron.

In one embodiment, this invention is directed to the electrochemical reduction of N₂ to NH₃ in an electrochemical cell comprising a cathode, an anode, a polyoxometalate catalyst, an alkali metal cation, a donor of a proton and/or an electron, and an electrolyte.

In one embodiment, this invention is directed to the electrochemical reduction of N₂ to NH₃ in an electrochemical cell comprising a cathode, an anode, a polyoxometalate catalyst, an alkali metal cation, a donor of a proton and/or an electron, and a solvent.

In one embodiment, this invention is directed to the electrochemical reduction of N₂ to NH₃ in an electrochemical cell comprising a cathode, an anode, a polyoxometalate catalyst, an alkali metal cation, a donor of a proton and/or an electron, a solvent and optionally an electrolyte.

In one embodiment, this invention is directed to the electrochemical reduction of N₂ to NH₃ in an electrochemical cell comprising a cathode, an anode, a polyoxometalate catalyst, an alkali metal cation, a solvent, water (as a donor of a proton and/or electron), and optionally an electrolyte.

In one embodiment, this invention is directed to the electrochemical reduction of N₂ to NH₃ in an electrochemical cell comprising a cathode, an anode, a polyoxometalate catalyst, an alkali metal cation, water (as a donor of a proton and/or electron), optionally an electrolyte and no solvent.

In one embodiment, the reduction proceeds in the presence of an alkali metal cation. In one embodiment, the reduction proceeds in the presence of an alkali metal cation and an electrolyte. In other embodiments, the electrolyte comprises a lithium, a sodium, a potassium or a quaternary ammonium salt. In yet another embodiment, the salt within the electrolyte comprises a cation comprising lithium, sodium, potassium or quaternary ammonium ion; and an anion comprising halide, pseudohalide, perchlorate, bis (trifluoromethylsulfonyl) imide, tetrafluoroborate, hexafluorophosphate, triflate, or an oxyanion. In another embodiment, the electrolyte comprises lithium perchlorate. In another embodiment, the electrolyte comprises tetrabutylammonom hexafluorophosphate (TBAPF₆). In another embodiment, the electrolyte comprises potassium triflate. In another embodiment, the electrolyte comprises sodium triflate.

In some embodiments, “halide” as used herein refers to fluoride, chloride, bromide or iodide.

In some embodiment, “pseudohalide” as used herein refers to a non-limiting group consisting of: cyanide, isocyanide, cyanate, isocyanate, thiocyanate, isothiocyanate and azide.

In some embodiments, “oxyanion” as used herein refers to a non-limiting group consisting of: nitrate, sulfate and perchlorate. In another embodiment, the electrolyte comprises sodium perchlorate.

In other embodiments, the electrochemical cell comprises a cathode, an anode, the polyoxometalate catalyst and optionally a reference electrode wherein voltage is applied to said cell thereby reducing N₂. The electrocatalytic reaction can be carried out in an undivided cell or divided cell configurations with a polymer or ceramic membrane separating the anode and cathode compartments. An example of a divided cell configuration is a gas phase flow cell membrane electrolyzer where the polyoxometalate is dissolved in a solvent or a gas diffusion electrolyzer.

In other embodiments, the electrocatalytic reduction of dinitrogen (N₂) is carried out in an undivided electrochemical cell configuration and in an organic solvent. In other embodiments, the electrocatalytic reduction of dinitrogen is carried out in a divided cell configuration with a polymer membrane separating the anode and cathode compartments. In other embodiments, the electrocatalytic reduction of dinitrogen is carried out in a divided cell configuration in an organic solvent, an electrolyte with a polymer membrane electrolyte separating the anode and cathode compartments. In other embodiments, the electrocatalytic reduction of dinitrogen is carried out in a divided cell configuration in an organic solvent, an electrolyte with a ceramic membrane separating the anode and cathode compartments. In other embodiments, the electrocatalytic reduction of dinitrogen is carried out in a gas diffusion flow cell membrane electrolyzer.

In some embodiment, the cathode within the electrochemical cell of this invention is a metal. In one embodiment the cathode comprises a metal. In another embodiment, the cathode comprises Ti, V, Cr, Mn, Fe, Co, Ni, Cu, Zn, Al, Mo or W or combinations thereof. In other embodiments, the cathode comprises Ti. In other embodiments, the cathode comprises V. In other embodiments, the cathode comprises Cr. In other embodiments, the cathode comprises Mn. In other embodiments, the cathode comprises Fe. In other embodiments, the cathode comprises Co. In other embodiments, the cathode comprises Ni. In other embodiments, the cathode comprises Cu. In other embodiments, the cathode comprises Zn. In other embodiments, the cathode comprises Al. In other embodiments, the cathode comprises Mo. In other embodiments, the cathode comprises W. In other embodiments the cathode comprises stainless steel. In another embodiment, the cathode is a Cu wire. In another embodiment, the cathode is a Cu foil. In another embodiment, the cathode is a Ni mesh. In another embodiment, the cathode is a stainless-steel mesh. In some embodiment, the cathode within the electrochemical cell of this invention comprises a carbon. In another embodiment the cathode comprises a microporous carbon. In another embodiment the cathode is mesoporous carbon.

In some embodiment, the anode within the electrochemical cell of this invention oxidizes water.

In some embodiments, the anode comprises Pt. In one embodiment, the anode is a Pt wire. In one embodiment the anode is platinized titanium.

In some embodiments, the the electrochemical reduction of dinitrogen (N₂) of this invention is carried out at a potential being <0 V vs. SHE. In other embodiments the “potential” refers to the IUPAC convention. In other embodiments, the electrochemical reduction of dinitrogen of this invention is carried out at a potential being <−1 V vs. SHE. In other embodiments, the electrochemical reduction of dinitrogen of this invention is carried out at a potential being <−2 V vs. SHE. In other embodiments, the electrochemical reduction of dinitrogen of this invention is carried out at a potential being between −2.5 and 0 V vs. SHE. In other embodiments, the electrochemical reduction of dinitrogen of this invention is carried out at a potential between −1.5V and −2.5V vs. SHE. In other embodiments, the electrochemical reduction of dinitrogen of this invention is carried out at a potential of −2, −2.15 or −2.4 V vs. SHE.

In some embodiments, the the electrochemical reduction of dinitrogen (N₂) of this invention is carried out under air or nitrogen enriched air. In other embodiments, the electrochemical reduction of dinitrogen of this invention is carried out with purified nitrogen. In other embodiments, the electrochemical reduction of dinitrogen of this invention is carried out at a dinitrogen (N₂) pressure of between 0.1 and 50 bar N₂. In other embodiments at a dinitrogen pressure of between 0.1 and 10 bar N₂. In other embodiments at a dinitrogen (N₂) pressure of between 0.1 and 5 bar N₂. In other embodiments at a dinitrogen pressure of between 0.1 and 3 bar N₂. In other embodiments at a dinitrogen (N₂) pressure of between 0.1 and 1 bar N₂. In another embodiment, the reduction of is done under atmospheric pressure. In other embodiments, the electrochemical reduction of dinitrogen of this invention is carried out at a dinitrogen (N₂) pressure of 1 bar N₂.

In some embodiments the electrocatalytic reduction of dinitrogen is carried out at a temperature of between 0-100° C. In other embodiments at a temperature of between 25-60° C. In other embodiments at a temperature of between 15-25° C. In other embodiments at a temperature of between 15-30° C. In other embodiments at a temperature of between 10-30° C. In other embodiments at ambient temperature.

In some embodiments, and without being bound by any mechanism or theory, it is contemplated herein that the electrocatalytic reduction of dinitrogen (N₂) of this invention proceeds via the following scheme 2:

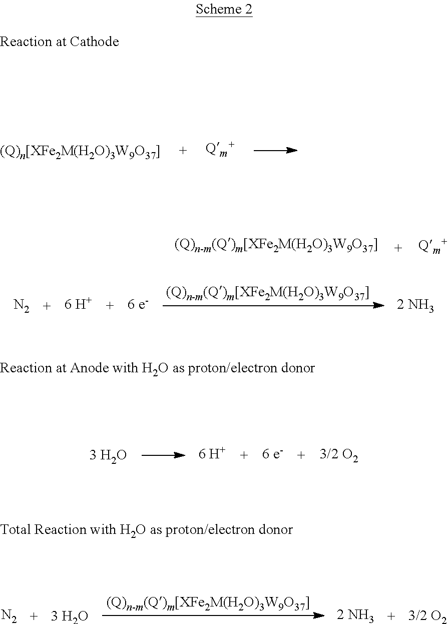

wherein:
Q′ is an alkali cation and m is an integer 2-5;
Q is a monovalent cation selected from the group consisting of a proton, an alkali metal cation, a nitrogen centered cation, a phosphorous centered cation and combinations thereof; and n is an integer between 3-17; and
n>m.

In some embodiments, the term “a donor of a proton and/or electron” as used herein refers to either “proton donor and electron donor” or “proton donor or electron donor”. The proton donor or electron donor refers that said species can donate a) proton; b) electron; or c) both a proton and an electron.

In some embodiments, the polyoxometalate is Q)ₙ[XFe₂M(L)₃W₉O₃₇] or solvate thereof solvate. The “solvate” refers to a solvated form of polyoxometalate with a solvent, such as water (hydrate), methanol, ethanol, and the like.

Various embodiments and aspects of the present invention as delineated hereinabove and as claimed in the claims section below find experimental support in the following examples.

### EXAMPLES

General: The synthesis of Q)ₙ[SiW₉Fe₃(L)₃W₉O₃₇] where L=H₂O and Q=tetrabutylammonium (TBA) was carried out according to the literature method (Liu, J.; Ortega, F.; Sethuraman, P.; Katsoulis, D. E.; Costello, C. E.; Pope, M. T. Trimetallo Derivatives of Lacunary 9-Tungstosilicate. J. Chem. Soc., Dalton Trans. 1992, 1901-1906). N₂ was purified until NOₓ and NH₃ could no longer be detected. Ammmonia was detected by the classical indophenol test for NH₄⁺ and by NMR (Nielander, A. C.; McEnany, J. M.; Schwalbe, J. A.; Baker, J. B.; Blair, S. J.; Wang, L.; Pelton, J. G.; Andersen, S. Z.; Enemark-Rasmussen, K.; Colic, V.; Tang, S. Bent. S. F.; Cargnello, M.; Kibsgaard, J.; Vesborg, P. C. K.; Chorkendorff, I.; Jaramillo, T. F. A Versatile Method for Ammonia Detection in a Range of Relevant Electrolytes via Direct Nuclear Magnetic Resonance Techniques. ACS Catal. 2019, 9, 5797-5802).

### Example 1

### Reduction of N₂ in the Presence of TBA₇[SiW₉Fe₃(H₂O)₃W₉O₃₇] in THE with Ethanol as a Donor of Proton and/or Electron

In a 20 mL undivided cell purified N₂ (1 bar) was circulated through a solution of 8 mL dried THF containing 3μmol TBA₇[SiW₉Fe₃(L)₃W₉O₃₇], 0.8 mmol TBAPF₆, 0.2 mmol LiClO₄ and 1% dried ethanol. After 5 h at −2.4 V versus SHE with a Cu wire cathode and a Pt wire anode, a 120 μM solution of NH₃ was obtained. There was no NH₃ formed in the absence of TBA₇[SiW₉Fe₃(L)₃W₉O₃₇] or LiClO₄. TBA refers to tetra butyl ammonium (Bu₄N⁺).

### Example 2

### Reduction of N₂ in the presence of TBA₇[SiW₉Fe₃(H₂O)₃O₃₇] in Glyme with Ethanol as a Donor of Proton and/or Electron

In a 20 mL undivided cell purified N₂ (1 bar) was circulated through a solution of 8 mL dried glyme containing 3μmol TBA₇[SiW₉Fe₃(L)₃W₉O₃₇], 0.8 mmol TBAPF₆, 0.2 mmol LiClO₄ and 1% dried ethanol. After 5 h at −2.4 V versus SHE with a Cu wire cathode and a Pt wire anode, a 125 μM solution of NH₃ was obtained. There was no NH₃ formed in the absence of TBA₇[SiW₉Fe₃(L)₃W₉O₃₇] or LiClO₄. TBA refers to tetra butyl ammonium (Bu₄N⁺).

### Example 3

### Reduction of N₂ in the presence of TBA₇[SiW₉Fe₃(H₂O)₃O₃₇] in Polyethylene Glycol with Ethanol as a Donor of Proton and/or Electron

In a 20 mL undivided cell purified N₂ (1 bar) was circulated through a solution of 8 mL dried polyethylene glycol-400 containing 3 μmol TBA₇[SiW₉Fe₃(L)₃W₉O₃₇], 0.8 mmol TBAPF₆, 0.2 mmol NaClO₄ and 1% dried ethanol. After 5 h at −2.4 V versus SHE with a Cu wire cathode and a Pt wire anode, a 100 μM solution of NH₃ was obtained. There was no NH₃ formed in the absence of TBA₇[SiW₉Fe₃(L)₃W₉O₃₇] or NaClO₄. TBA refers to tetra butyl ammonium (Bu₄N⁺).

### Example 4

### Reduction of N₂ in the presence of TBA₇[SiW₉Fe₃(H₂O)₃O₃₇] in Polyethylene Glycol as a Donor of Proton and/or Electron

In a 20 mL undivided cell purified N₂ (1 bar) was circulated was circulated through a solution of 8 mL dried polyethylene glycol-400 containing 3μmol TBA₇[SiW₉Fe₃(L)₃W₉O₃₇], 0.8 mmolTBAPF₆, 0.2 mmol NaClO₄. After 5 h at −2.4 V versus SHE with a Cu wire cathode and a Pt wire anode, a 22 μM solution of NH₃ was obtained. There was no NH₃ formed in the absence of TBA₇[SiW₉Fe₃(L)₃W₉O₃₇] or NaClO₄. TBA refers to tetra butyl ammonium (Bu₄N⁺).

### Example 5

### Reduction of N₂ in the presence of TBA₇[SiW₉Fe₃(L)₃W₉O₃₇] in Polyethylene Glycol with Water as a Donor of Proton and/or Electron

In an undivided cell consisting of 20 mL air tight vial, purified N₂ (1 bar) was circulated through a solution of 8 mL dried polyethylene glycol-400 containing 3 μmol TBA₇[SiW₉Fe₃(L)₃W₉O₃₇], 0.8 mmol TBAPF₆, 0.2 mmol NaClO₄ and 1% H₂O. After 5 h at −2.4 V versus SHE with a Cu wire cathode and a Pt wire anode, a 112 μM solution of NH₃ was obtained. There was no NH₃ formed in the absence of TBA₇[SiW₉Fe₃(L)₃W₉O₃₇] or NaClO₄. TBA refers to tetra butyl ammonium (Bu₄N⁺).

### Example 6

### Synthesis of Q₇[SiW₉Fe₃(H₂O)₃W₉O₃₇] where Q=R₁R₂R₃R₄N⁺ where R₁₌ethyl; R₂₌tallow; R₃ and R₄ are (CH₂CH₂O)ₘH where m=6-20

The potassium salt K₇[SiW₉Fe₃(H₂O)₃W₉O₃₇] was reacted with dried IoLiLyte T2EG (ethylbis (hydroxyethyl) tallow alkyl ethylsulfate). In a separatory funnel 15 ml of IoLiLyte T2EG were mixed with 30 ml of DCM and 1 g K₇[SiW₉Fe₃(H₂O)₃W₉O₃₇] in 30 ml DDW. The solution was stirred vigorously several times and the bottom crude phase was separated and dried using rotatory evaporator, the resulting product was an oily liquid.

### Example 7

### Reduction of N₂ using the Catalyst of Example 6 with Ethanol as a Donor of Proton and/or Electron

In an undivided cell consisting of 20 mL air tight vial, purified N₂ (1 bar) was circulated through 6 mL Q₇[SiW₉Fe₃(H₂O)₃W₉O₃₇] oily liquid from Example 6 containing, 0.4 mmol LiClO₄ and 1 vol % dry ethanol. After 5 h at −2.4 V versus SHE with a Cu wire cathode and a Pt wire anode, 0.9 μmol NH₃ was obtained.

### Example 8

### Reduction of N₂ in the presence of K₇[SiW₉Fe₃(H₂O)₃O₃₇] in Polyethylene Glycol with Water as a Donor of Proton and/or Electron

In a 20 mL undivided cell purified N₂ (1 bar) was circulated through a solution of 8 mL dried polyethylene glycol-400 containing 3 μmol K₇[SiW₉Fe₃(L)₃W₉O₃₇], 0.8 mmol potassium triflate, 0.2 mmol NaClO₄ and 1% H₂O. After 3 h at −2.4 V versus SHE with a Cu wire cathode and a Pt wire anode, a 115 μM solution of NH₃ was obtained. There was no NH₃ formed in the absence of K-[SiW,Fe; (L)₃W₉O₃₇] or NaClO_{4.}

### Example 9

### Reduction of N₂ in the presence of K₇[SiW₉Fe₃(H₂O)₃W₉O₃₇] in Polyethylene Glycol with Water as a Donor of Proton and/or Electron

In a 20 mL undivided cell purified N₂ (1 bar) was circulated through a solution of 8 mL dried polyethylene glycol-400 containing 3 μmol mM K₇[SiW₉Fe₃(L)₃W₉O₃₇], 0.8 mmol potassium triflate, 0.2 mmol NaClO₄ and 1% H₂O. After 3 h at −2.4 V versus SHE with a Cu foil cathode and a Pt wire anode, a 122 μM solution of NH₃ was obtained. There was no NH₃ formed in the absence of K₇[SiW₉Fe₃(L)₃W₉O₃₇] or NaClO₄.

### Example 10

### Reduction of N₂ in the presence of K₇[SiW₉Fe₃(H₂O)₃O₃₇] in Polyethylene Glycol with Water as a Donor of Proton and/or Electron

In a 20 mL undivided cell purified N₂ (1 bar) was circulated through a solution of 8 mL dried polyethylene glycol-400 containing 3 μmol K₇[SiW₉Fe₃(L)₃W₉O₃₇], 1.0 mmol sodium triflate, and 1% H₂O. After 3 h at −2.4 V versus SHE with a Cu foil cathode and a Pt wire anode, a 135 μM solution of NH₃ was obtained.

### Example 11

### Reduction of N₂ in the presence of K₇[SiW₉Fe₃(H₂O)₃O₃₇] in Polyethylene Glycol with Water as a Donor of Proton and/or Electron

In a 20 mL undivided cell purified N₂ (1 bar) was circulated through a solution of 8 mL dried polyethylene glycol-400 containing 3 μmol K₇[SiW₉Fe₃(L)₃W₉O₃₇], 0.8 mmol potassium triflate, 0.2 mmol NaClO₄ and 1% H₂O. After 3 h at −2.4 V versus SHE with a Ni mesh cathode and a Pt wire anode, a 180 μM solution of NH₃ was obtained.

### Example 12

### Reduction of N₂ in the presence of K₇[SiW₉Fe₃(H₂O)₃W₉O₃₇] in Polyethylene Glycol Dimethylether with Water as a Donor of Proton and/or Electron

In a 20 mL undivided cell purified N₂ (1 bar) was circulated through a solution of 8 mL dried polyethylene glycol-400 dimethylether containing 3 μmol K₇[SiW₉Fe₃(L)₃W₉O₃₇], 0.8 mmol potassium triflate, 0.2 mmol NaClO₄ and 1% H₂O. After 3 h at −2.4 V versus SHE with a Ni mesh cathode and a Pt wire anode, a 165 μM solution of NH₃ was obtained.

### Example 13

### Reduction of N₂ in the presence of K₇[SiW₉Fe₃(H₂O)₃W₉O₃₇] in Polyethylene Glycol with Water as a Donor of Proton and/or Electron

In a 20 mL undivided cell purified N₂ (1 bar) was circulated through a solution of 8 mL dried polyethylene glycol-400 containing 3 μmol K₇[SiW₉Fe₃(L)₃W₉O₃₇], 0.8 mmol potassium triflate, 0.2 mmol NaClO₄ and 1% H₂O. After 3 h at 2.4 V versus SHE with a stainless-steel mesh cathode and a Pt wire anode, a 195 μM solution of NH₃ was obtained.

1-25 (canceled)

26. A method for the preparation of ammonia, the method comprising:
electrochemically reducing dinitrogen in an electrochemical cell in the presence of a polyoxometalate catalyst, an alkali metal cation, and a donor of a proton and/or an electron.

27. The method of claim 26 wherein the polyoxometalate catalyst comprises iron.

28. The method of claim 26 wherein the polyoxometalate catalyst comprises the general formula (Q)ₙ[XFe₂M(L)₃W₉O₃₇] or solvate thereof wherein:
X is a group 13, 14, or 15 atom;
M is a metal;
L comprises an atom associated with M;
Q is a cation; and
n is an integer 3 to 17.

29. The method of claim 28 wherein:
X is P, Si, As, Ge, Ga, B, or Al;
M is Cr, Mn, Fe, Co, Ni, Cu, Zn, Al, Ga, Sc, Mg, Y, Ba, or Ca;
L is H₂O, carboxylate, oxyanion, halide, pseudohalide, null or any combination thereof;
Q is a cation; and
n is an integer 3 to 17.

30. The method of claim 28 wherein Q is a proton, an alkali metal cation, an alkaline earth metal cation, a lanthanide cation, a nitrogen centered cation, a phosphorous centered cation and combinations thereof.

31. The method of claim 28 wherein X is P.

32. The method of claim 28 wherein X is Si.

33. The method of claim 28 wherein X is As.

34. The method of claim 28 wherein X is Ge.

35. The method of claim 28 wherein X is Ga.

36. The method of claim 28 wherein X is B.

37. The method of claim 28 wherein X is Al.

38. The method of claim 28 wherein L is null.

39. The method of claim 29 wherein L is H₂O.

40. The method of claim 28 wherein Q is a proton.

41. The method of claim 28 wherein Q comprises a lanthanide cation.

42. The method of claim 28 wherein Q comprises a nitrogen centered cation.

43. The method of claim 28 wherein Q comprises a phosphorous centered cation.

44. The method of claim 28 wherein [XFe2M(L)3W9O37] is [SiFe3(L)3W9O37].

45. The method of claim 26 further comprising an electrolyte.
